(19) United States
(12) Patent Application Publication
(10) Pub. No.: US 2002/0143869 A1
(43) Pub. Date: Oct. 3, 2002

(54) Method and apparatus for making random introductions electronically

(76) Inventor: Hal Cohen, Cherry Hill, NJ (US)

Correspondence Address: DUANE MORRIS, LLP, ATTN: WILLIAM H. MURRAY, ONE LIBERTY PLACE, 1650 MARKET STREET, PHILADELPHIA, PA, 19103-7396, US

(21) Appl. No.: 09/754,410

(22) Filed: Jan. 3, 2001

(51) Int. Cl. G06F 15/16

(52) U.S. Cl. 709/204; 709/229

(57) ABSTRACT

A method for facilitating communications between persons, comprising the steps of: sensing when two or more persons come in contact with one another by storing a unique code in transceiver units disposed on each of the two or more persons, providing an electronic medium for entering the unique codes stored on the transceiver units, and randomly matching pairs of users based on a matching program accessible by the electronic medium.

### FIELD OF THE INVENTION

The present invention relates to a method and apparatus for facilitating interactions between persons, and in particular a method and apparatus for determining when one person comes in close proximity to another person or persons for purposes of facilitating electronic communications between the persons.

### DESCRIPTION OF THE RELATED ART

The use of the Internet as a means of communication has become increasingly popular in recent years. The Internet includes a plurality of means of communication such as: electronic mail (e-mail), bulletin boards and real-time messaging. One of the most popular means of communication on the Internet is on-line “chat”. On-line “chat” programs allow two or more persons located at different computers to converse with one another over the Internet in close to real time.

There are currently many different types of “chat” programs on the market. Some of these “chat” programs allow communications between only two users at a time in a shared window (e.g., America Online Instant Messenger™, Yahoo! Messenger™, etc.), and some allow communications between any number of users in a shared window typically known as a “chat room.”

There are various “chat rooms” which exist on the Internet, dedicated to a variety of topics. Typically, computer users who are interested in a particular topic will enter the associated “chat room” and attempt to engage in conversations with other members of the chat room. However, when engaging in conversations with others over the Internet, one has no idea if the persons they are talking to have common interests, or even live in a nearby area so that more personal introductions would be possible.

Additionally, there has recently been increased interest in games which are played over the Internet. For example, there are many computing systems available which allow users to play games interactively over the Internet (e.g., personal computers, Sega Dreamcast™, Sony Playstation 2™, etc.). These systems allow users who have common interests in a particular game to communicate with one another through the medium of the game. However, there is presently no efficient method for personally introducing the participants in the game to one another.

Therefore, there is currently a need for a method and apparatus for making random introductions electronically through the medium of a game.

### SUMMARY OF THE INVENTION

The present invention is a method for facilitating communications between persons, comprising the steps of: sensing when two or more persons come in contact with one another by storing a unique code in transceiver units disposed on each of the two or more persons, providing an electronic medium for entering the unique codes stored on the transceiver units, and randomly matching pairs of users based on a matching program accessible by the electronic medium.

The above and other advantages and features of the present invention will be better understood from the following detailed description of the preferred embodiments of the invention which is provided in connection with the accompanying drawings.

### BRIEF DESCRIPTION OF THE DRAWINGS

FIG. 1 is a block diagram showing a computer system according to a preferred embodiment of the present invention.

FIG. 2 is a schematic diagram showing a preferred embodiment of a transceiver device for use with the present invention.

FIG. 3 is a flow diagram showing a main process according to the present invention.

FIG. 4 is a flow diagram showing a device registration process according to the present invention.

FIG. 5 is a flow diagram showing a login process according to the present invention.

FIG. 6 is a flow diagram showing a close encounter registration process according to the present invention.

FIG. 7 is a flow diagram showing a matching process according to the present invention.

FIG. 8 is a flow diagram showing a matching routine process according to the present invention.

FIG. 9 is a drawing showing databases according to the present invention.

FIG. 10 is a drawing showing a screen shot of a main webpage according to the present invention.

FIG. 11 is a drawing showing a screen shot of a registration webpage according to the present invention.

FIG. 12 is a drawing showing a screen shot of a login webpage according to the present invention.

FIG. 13 is a drawing showing a screen shot of a close encounters registration webpage according to the present invention.

FIG. 14 is a drawing showing a screen shot of a close encounters confirmation webpage according to the present invention.

FIG. 15 is a drawing showing a screen shot of a user preferences webpage according to the present invention.

FIG. 16 is a drawing showing a screen shot of a close encounters webpage according to the present invention.

### DETAILED DESCRIPTION

The present invention comprises a system and method and process for making random introductions between persons electronically. The system is basically comprised of two main elements: a plurality of transceiver devices and a plurality of user computers connected together through a network (e.g., Internet). Each individual engaging in the process preferably carries on his or her person one of the plurality transceiver devices. When persons carrying the transceiver devices come in close proximity to one another (e.g., 1-10 feet), the transceivers exchange unique codes which are stored in a computer memory in the respective transceivers. The transceiver devices include a display through which the user thereof can determine the unique codes which have been stored in the computer memory. The user may then enter the unique codes stored in the transceiver into a computer which is connected to at least one server computer through a network (such as the Internet). A program module stored on the server computer provides information to the user on the persons they have come in close proximity to based on the unique codes entered by each user. Users may then contact one another through the network, utilizing electronic mail (e-mail), a chat program or the like. In the exemplary embodiment of the invention, users may also contact one another through the network to play a mystery game, such as, for example, a game to guess who the other user may be. Thus, persons engaging in the process who would typically not know each other personally can thereby be introduced to one another electronically.

Throughout the present application the system and process for making random introductions electronically is generally referred to as the “Is It Fate” or “IIF” system or process, and the transceiver devices are sometimes referred to as “Faters.” It should be noted that these are arbitrary terms chosen by the present inventor and are not limiting of the present invention.

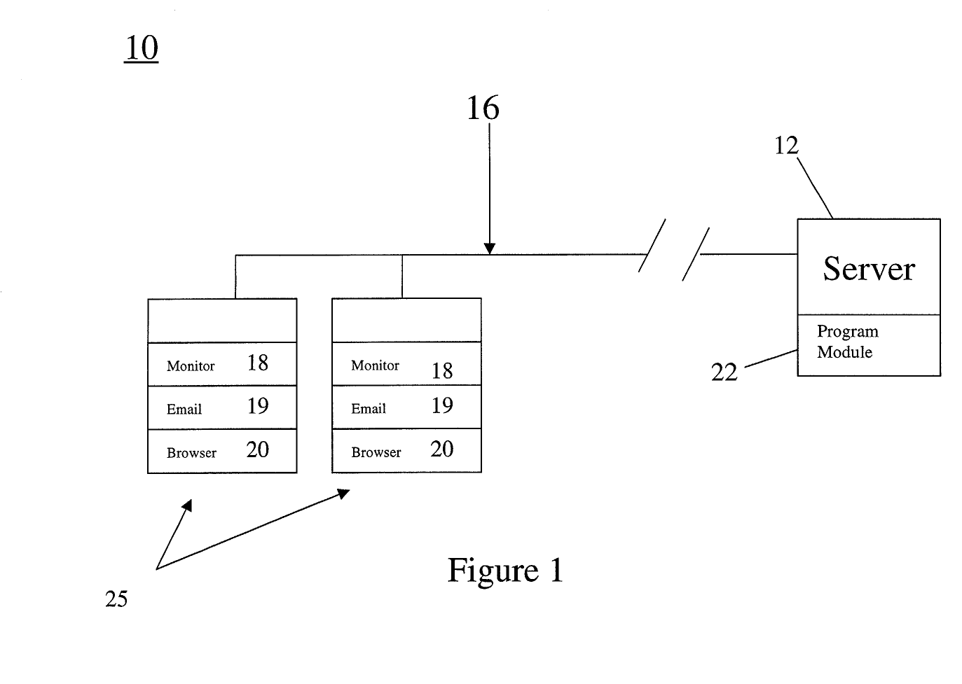

Referring to FIG. 1, there is shown a system 10 according to an exemplary embodiment of the present invention. The system 10 includes at least one server computer 12 and a plurality of user computers 25 (clients). The server computer 12 and the user computers 25 may be connected by a network 16, such as for example, an Intranet or the Internet. The user computers 25 may be connected to the Intranet or Internet by a modem connection, a Local Area Network (LAN), cable modem, digital subscriber line (DSL), or other equivalent connection means.

Each user computer 25 preferably includes a video monitor 18 for displaying information. Additionally, each user computer 25 preferably includes an electronic mail (e-mail) program 19 (e.g., Microsoft Outlook®) and a browser program 20 (e.g. Microsoft Internet Explorer®, Netscape Navigator®, etc.), as is well known in the art.

The server computer 12 preferably includes a program module 22 (explained in detail below) which allows the user computers 25 to communicate with the server computer and each other over the network 16. The program module 22 may include program code, preferably written in Hypertext Mark-up Language (HTML), JAVA™ (Sun Microsystems, Inc.), Active Server Pages (ASP) and/or Extensible Markup Language (XML), which allows the user computers 25 to access the program module through browsers 20 (i.e., by entering a proper Uniform Resource Locator (URL) address) and enter information. The exemplary program module 22 also preferably includes a program for facilitating communications between users stationed at user computers 25, which is explained in detail below.

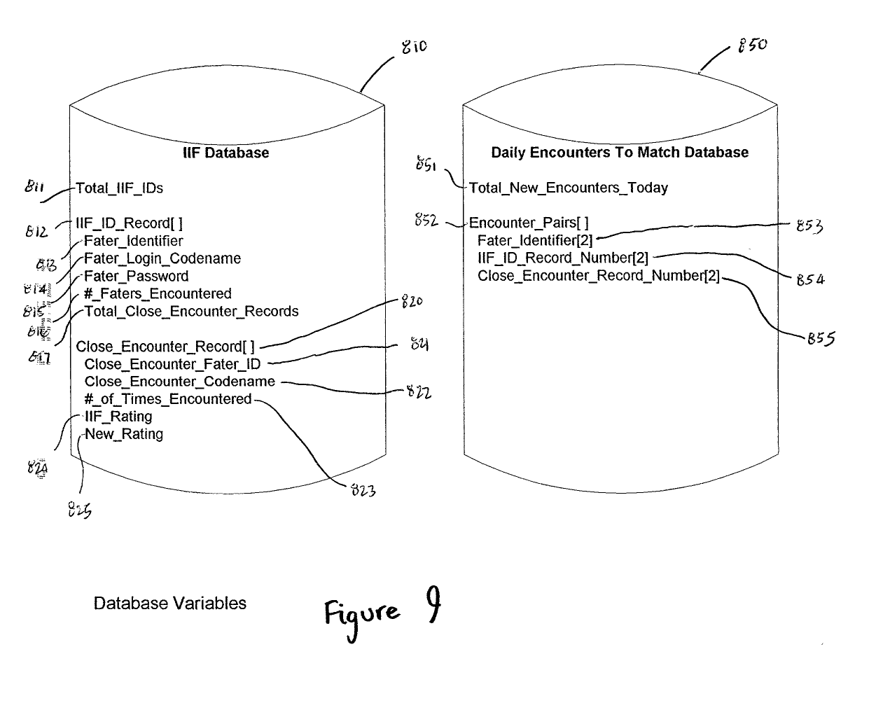

The server computer 12 also preferably includes at least two databases 810, 850 for storing information used in the present process and in conjunction with the program module 22 (See FIG. 9). A first “IIF Database” 810 includes information on each user of the system, and a second “Daily Encounters To Match Database” 850 for temporarily storing information for matching users of the present process with one another.

The IIF Database 810 includes a plurality of arrays of data including a Total IIF IDs array 811 which includes all relevant information on each user of the system, and which tracks the total number of login IDs which are registered to specific users. Within the array 811 there are included several sub-arrays, such as a IIF ID Record array 812 which includes an entry for each registered user of the system. Each record in the IIF ID Record array 812 preferably includes at least five (5) components, a Fater Identifier component 813 which lists the unique code or Serial Number of a specific transceiver device 100 (‘Fater’), a Fater Login Codename component 814 which lists a specific user login ID, a Fater Password component 815 which lists a specific user password, a Number of Faters Encountered component 816 which lists a specific number of Faters encountered, and a Total Number of Close Encounters component 817 which lists the total number of close encounters for a specific user.

The Total IIF IDs array 811 also includes other sub-arrays, such as a Close Encounter Record array 820 associated with each user of the system and which includes an entry for each close encounter that the particular user has registered. Each record in the Close Encounter Record array 820 preferably includes at least five (5) components, a Close Encounter Fater ID component 821 which lists a specific unique code or Serial Number of another user which has been encountered, a Close Encounter Codename component 822 which lists a specific Fater login ID of another user which has been encountered, a Number of Times Encountered component 823 which lists the number of times the other user has been encountered, an IIF Rating component 824 which lists a rating for the other user (explained below), and a New Rating component 825 which lists whether the other user has been encountered and rated recently.

In the exemplary embodiment of the invention there are five (5) different ‘ratings’: “IIF Winner!!!”, “Could Be Fate”, “Fifty-Fifty”, “Better Not” and “Looking for Trouble”, however, any number of preference ratings may be utilized. Each of the ‘ratings’ preferably has a corresponding reference number, which in the exemplary embodiment are as follows in the table below:

| Rating | Reference Number |
|---|---|
| IIF Winner!!! | 1 |
| Could Be Fate | 2 |
| Fifty-Fifty | 3 |
| Better Not | 4 |
| Looking for Trouble | 5 |

The details of the different ratings and their associated reference numerals are explained in more detail below.

The Daily Encounters To Match Database 850 also includes a plurality of arrays of data including a Total New Encounters Today array 851 for storing a number indicative of the total number of ‘close encounters’ which occur in any specific day. It should be noted that the Daily Encounters To Match Database 850 is updated on a regular basis, preferably once daily at some time when user activity is low (e.g., 4:00 am). The database 850 includes an Encounter Pairs array 852 which includes an entry for each pair of users who have had a ‘close encounter’ during a specific polling period (e.g., from 4:00 am on Day1 to 4:00 am on Day 2). Each record in the Encounter Pairs array 852 preferably includes at least three (3) components, a Fater Identifier component 853 which lists the specific unique codes or Serial Numbers of the two users who have had a ‘close encounter’, an IIF ID Record Number component 854 which identifies the particular records in the IIF ID Record array 812 which correspond to the two users who have had a ‘close encounter’, and a Close Encounter Record Number component 855 which identifies the particular records in each of the users Close Encounter Record arrays 820 which correspond to the other user.

For example, if the system had only two users who both had registered transceiver devices 100 (‘Faters’), the Total IIF IDs array 811 would hold the number 2, and the IIF ID Record array 812 would include two entries. Presuming that a first user has a transceiver device 100 (‘Fater’) with a Serial Number or unique code of #0000001, and a second user has a transceiver device with a Serial Number or unique code of #0000002, a first entry in the IIF ID Record array might appear as below:

IIF_ID_Record [1]
Fater_Identifier = 0000001
Fater_Login_Codename = Cocheese
Fater_Password = jimmy
#_Faters_Encountered = 0
Total_Close_Encounter_Records = 0

And a second entry might appear as:

IIF_ID_Record [2]
Fater_Identifier = 0000002
Fater_Login_Codename = Kahuna
Fater_Password = surfsup
#_Faters_Encountered = 0
Total_Close_Encounter_Records = 0

Presuming also that the two users come in close proximity (e.g., 1-10 feet) to one another on a specific day, the process will create entries in each users Close Encounter Record array 820, such as below:

Cocheese Close_Encounter_Record [1]
Close_Encounter_Fater_ID = 0000002
Close_Encounter_Codename = Kahuna
#_of_Times_Encountered = 1
IIF_Rating = 0
New_Rating = 0
Kahuna Close_Encounter_Record [1]
Close_Encounter_Fater_ID = 0000001
Close_Encounter_Codename = Cocheese
#_of_Times Encountered = 1
IIF_Rating = 0
New_Rating = 0

At the end of the polling period, the process loads the information obtained from the users into the Daily Encounters To Match Database 850. Using the above example, the Total New Encounters Today array 851 would hold the number 1, and the Encounter Pairs array 852 would include a single entry as shown below:

Encounter_Pairs [1]
Fater_Identifier = [0000001, 0000002]
IIF_ID_Record_Number = [1,2]
Close_Encounter_Record_Number = [1, 1]

When the Daily Encounters To Match Database 850 is updated, the Close Encounter Record array 820 for each user is also preferably updated with a ‘rating’ as shown below:

Cocheese Close_Encounter_Record [1]
Close_Encounter_Fater_ID = 0000002
Close_Encounter_Codename = Kahuna
#_of_Times_Encountered = 1
IIF_Rating = 3
New_Rating = 1
Kahuna Close_Encounter_Record [1]
Close_Encounter_Fater_ID = 0000001
Close_Encounter_Codename = Cocheese
#_of_Times_Encountered = 1
IIF_Rating = 3
New_Rating = 1

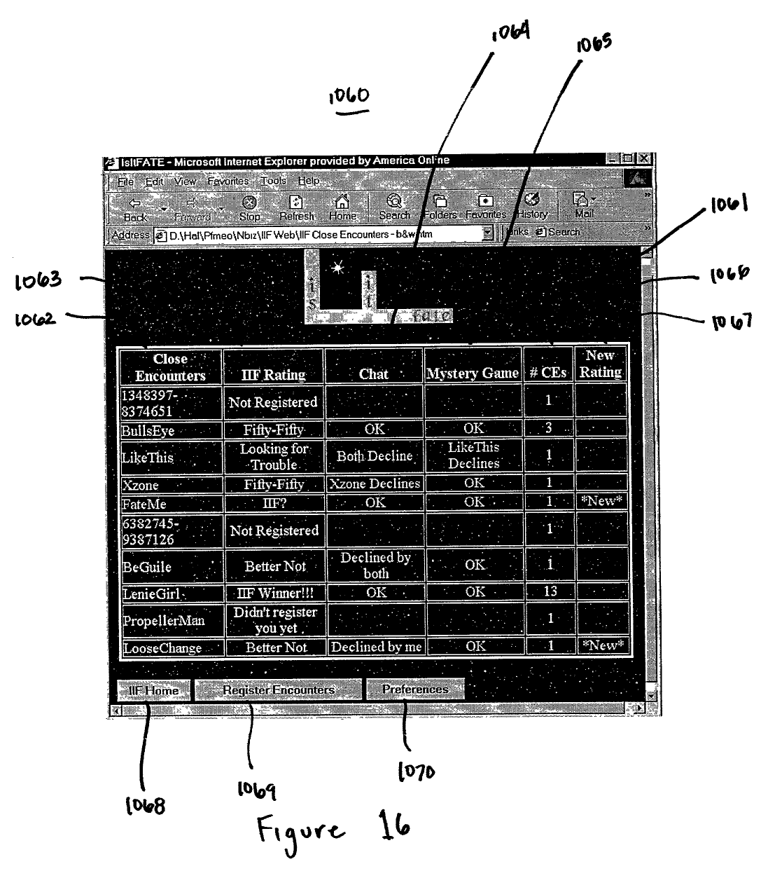

It should be noted that each encounter pair will always have the same ‘rating’ number. In this case, the ‘rating’ number assigned by the present process is “3” indicating that the users may are a “Fifty-Fifty” match (explained below). Also, the New Rating component 825 for each user is set to “1” indicating that the ‘rating’ has been performed recently and should be marked as such on ‘close encounters’ page 1060 (See New Rating column 1067 in FIG. 16).

It should be noted that the above-described process for storing information in databases may be performed for any number of users having any number of ‘close encounters.’ Although the program is referred to herein as a program for facilitating communications between computer users who are previously unknown to one another, the program may be used for other purposes. The capabilities described below are not limited to such a program, and other embodiments of the program that are specifically adapted to other types of communications are also contemplated as within the scope of the invention.

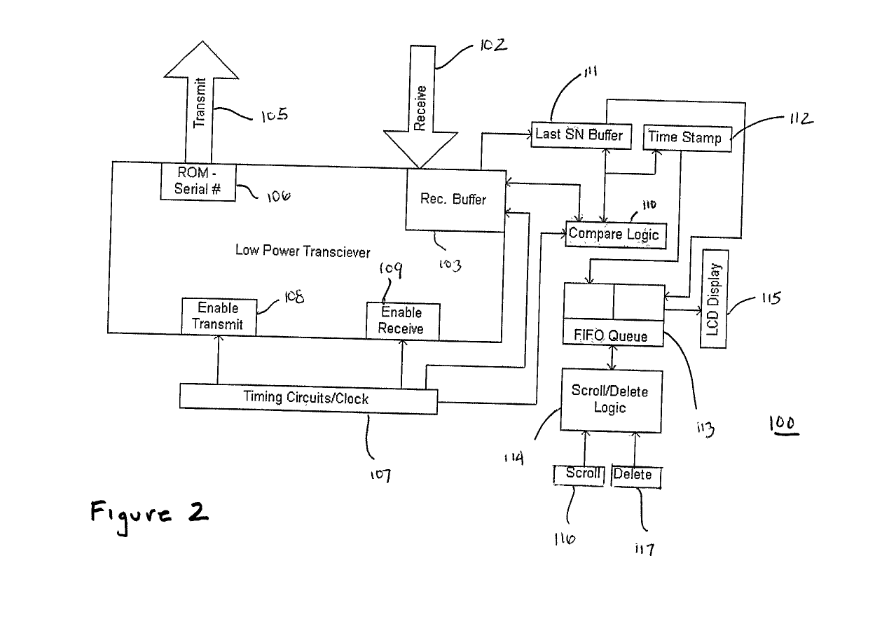

FIG. 2 is a schematic diagram showing a transceiver device 100 according to an exemplary embodiment of the present invention. The transceiver device 100 includes an antenna or antennae (not shown) for sending and receiving signals or information. Received signals are routed from the antenna through receive path 102 to a receive buffer 103. The transceiver device 100 also includes a transmit path 105 which continually provides a unique code signal (explained below) to the antenna from a Read-Only Memory (ROM) 106. The transceiver device 100 also includes a timer circuit 107 which provides clock signals to transmit enable logic 108 and receive enable logic 109 so that the transceiver device 100 may intermittently transmit and receive information. The timer circuit 107 also provides clock signals to the receive buffer 103, and to compare logic 110. The clock signal provided to the receive buffer 103 ensures that received signals are loaded into the receive buffer during a receive cycle, and not during a transmit cycle. The clock signal provided to the compare logic 110 by the timer circuit 107 enables the comparison of the last two serial numbers received over receive path 102.

The transceiver device 100 also includes a serial number buffer 111 for storing each unique code temporarily before they are passed on to a FIFO register 113 (described below), a time stamp circuit 112 for initiating a time delay (explained below), a first-in-first-out (FIFO) register 113 for storing unique codes in the order in which they are received on receive path 102, control logic 114 for scrolling through unique codes stored in the FIFO register 113 and for deleting unique codes stored in the FIFO register, and a liquid crystal display (LCD) 115 for displaying to a user the unique codes stored in the FIFO register 113. The transceiver device 100 also preferably includes “scroll” and “delete” buttons 116, 117 disposed on an exterior thereof which are coupled to the control logic 114. The “scroll” and “delete” buttons allow a user to selectively scroll through and delete unique codes stored in the FIFO register 113 simply by pressing a button.

When the unique code (serial number) in the serial number buffer 111 is not equal to the serial number in the receive buffer 103, the contents of the serial number buffer 111 will be stored in the FIFO register 113, and the contents of the receive buffer will be stored in the serial number buffer. This limits the FIFO register 113 to one instance of a serial number at a given time.

The FIFO register 113 stores unique codes which are received over the receive path 102 in the order in which they are received, for example, the first unique code received is stored in a first position in the FIFO register, a second unique code in a second position, and so on. When a user displays the unique codes utilizing the LCD 115 and the control logic 114, the code which was entered first is displayed first. Utilizing the above example, the code in position one would be displayed first, and then the code in position two. However, the time stamp circuit 112 provides for a time delay between receipt of the unique code or codes over the receive path 102 and the ability to display the codes on the LCD 115. For example, the time stamp circuit 112 sets a timer each time a new unique code is received, and passes the unique code to the FIFO register 113 only after a specified time (e.g., 2 hours) has elapsed. The time stamp circuit 112 ensures the privacy of the individuals involved in the process by preventing users from knowing the exact moment when another user passes by them, and adds intrigue to the encounter.

As stated above, a transceiver device 100 as described above is carried on the person of each participant in the present process. The transceiver device 100 continually sends a unique code signal through transmit path 105, and receives incoming unique codes through receive path 102. At any time the user may examine the unique codes which have been received by utilizing the LCD 115 and the “scroll” button 116 coupled to the control logic 114. If a user wishes to delete a particular unique code or codes, the “delete” button 117 coupled to control logic 114 may be utilized. As described above, there is a certain time delay between actual receipt of the unique codes and the ability to display the unique codes on the LCD 115 imposed by the time stamp circuit 112 to ensure privacy of the users.

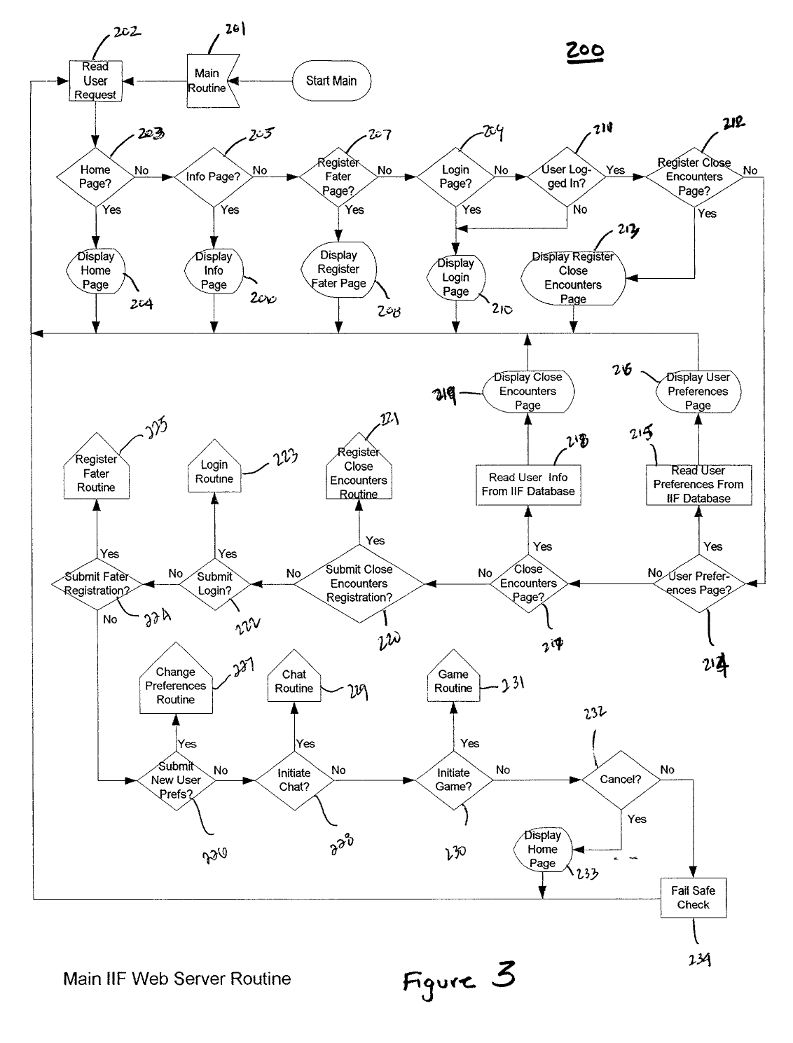

FIG. 3 is a flow chart showing the basic process 200 which is implemented utilizing a program or programs stored on the program module 22 of the server 12. The program module 22 typically comprises an HTML or XML programmed website which is accessible via the network 16. The process 200 typically begins when a user of the one of the user computers 25 accesses the program module 22 by, for example, entering a particular Uniform Resource Locator (URL) (e.g., “www.isitfate.com”) into the browser program 20 stored on the particular user computer. This brings the user to the main webpage 1000 associated with the present process (step 201).

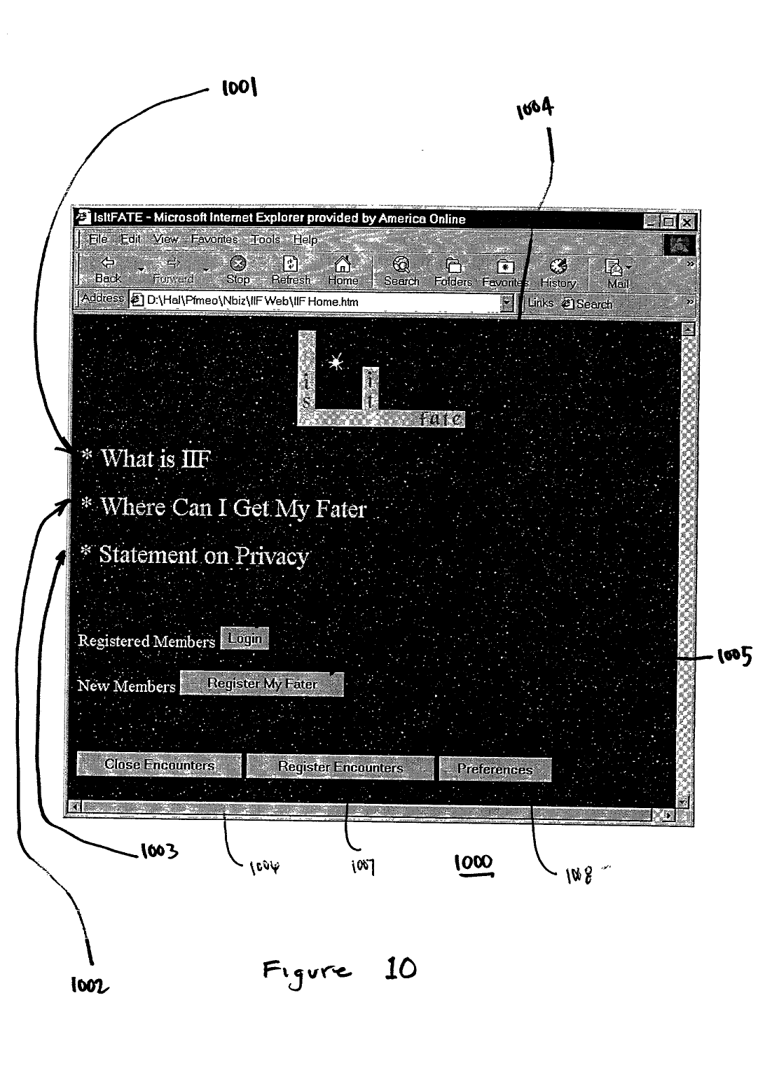

FIG. 10 shows the main webpage 1000 which will be presented on the video monitor 18 of the user computer 25 when accessing the website as discussed above. As shown, the main webpage 1000 includes hyperlinks to, among other things, a description of the Is It Fate process 1001 (e.g., What is IIF?), information on where to obtain a transceiver device 1002 (e.g., Where can I get my Fater?), and a privacy statement 1003 (Statement on Privacy). More importantly, the main webpage 1000 presents the user with hyperlinks allowing the user to login to the system 1004, or register their transceiver device 1005 (if the user is a first time visitor to the website). The main webpage 1000 also includes selection buttons (as are well known in the art), such as, “close encounters” button 1006, a “register encounters” button 1007, and a “preferences” button 1008. As explained in detail below, the services offered by these buttons are preferably only available once a user had ‘logged in’ to the system. Of course the above-described hyperlinks and selection buttons are merely intended as exemplary, and it should be noted that any number of hyperlinks or selection buttons may presented to a user at the main webpage 1000.

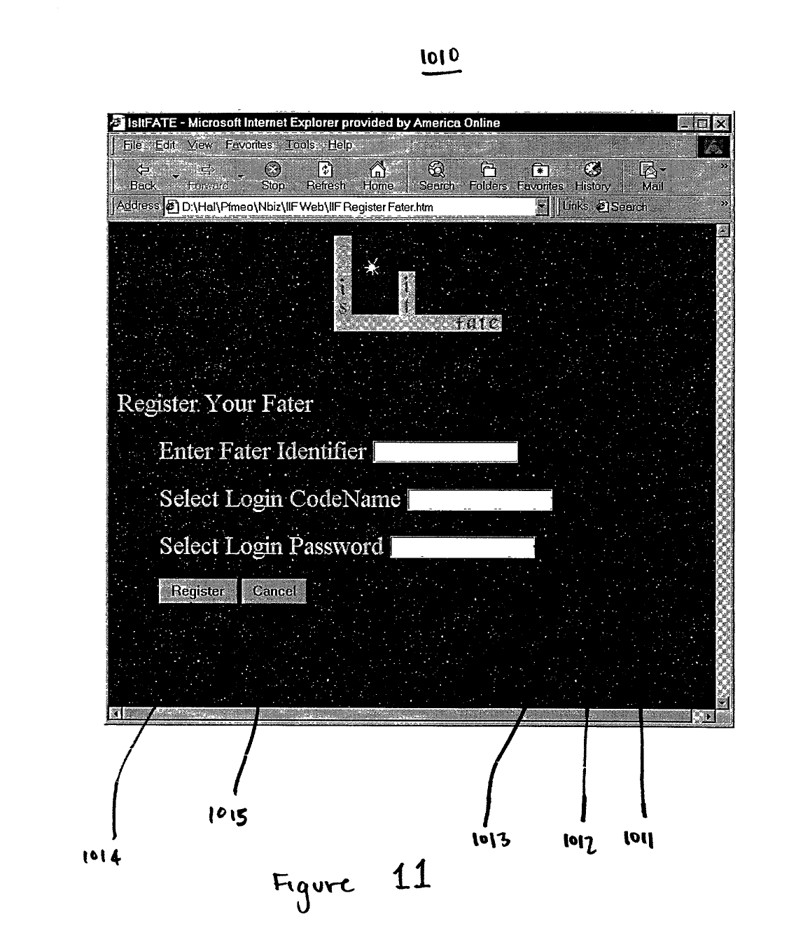

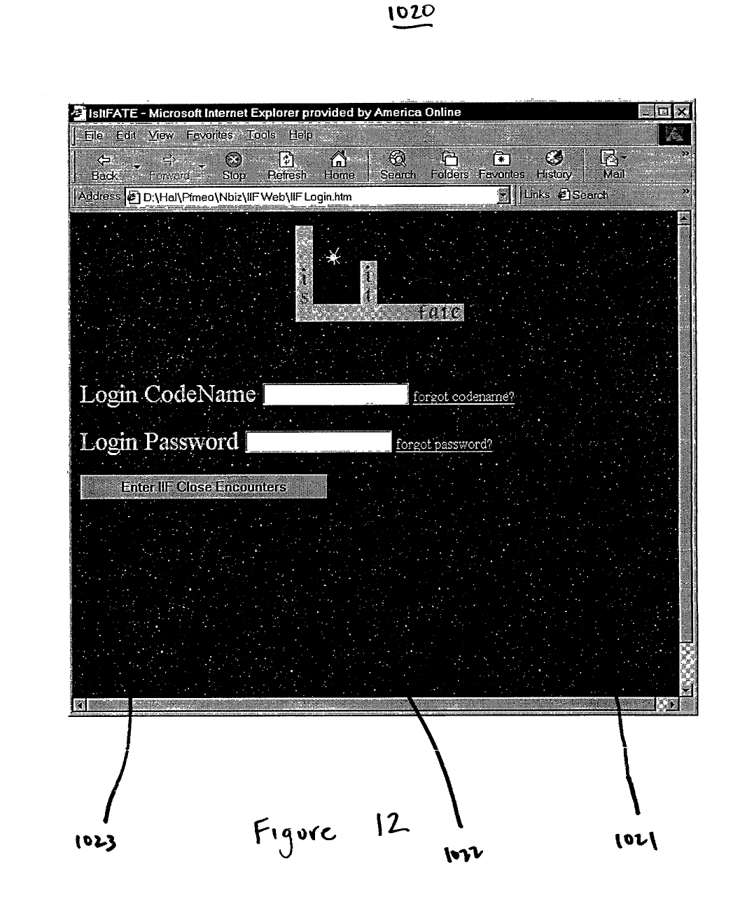

Referring again to FIG. 3, the present process 200 continually monitors requests made by the user computer(s) 25 at step 202, and presents information accordingly. For example, if a user requests that the main webpage 1000 be presented at step 203 (e.g., by clicking on the ‘Refresh’ button of the browser program 20), the program module 22 (implementing the process 200) presents the main webpage at step 204. Similarly, if the user selects the informational hyperlink 1001 at step 205, the program module 22 presents an informational webpage at step 206. Further, if the user selects the registration hyperlink 1004 at step 207, the program module 22 presents a registration webpage 1010 at step 208 (See FIG. 11). Finally, if a user selects the login hyperlink 1004 at step 209, the user will be presented with a login webpage 1020 (See FIG. 12) at step 210 which allows the user to login to the system by entering certain personal information (e.g., login identification (ID), password, etc.).

Once a user is ‘logged in’ to the system (as determined at step 211), the user may access many additional features of the present process 200. For example, the user may register ‘close encounters’ (at step 212), create or edit user preferences (at step 214), or display previously entered ‘close encounters’ (at step 217).

‘Close encounters’ is a term used by the present applicant to refer to the transfer of information which occurs when two or more transceiver devices 100 described above come in close proximity to one another. The user may register these ‘close encounters’ by, for example, reading the data off of his or her transceiver device 100 (utilizing “scroll” button 116 and the LCD 115 of the transceiver) and entering such data into the program module 22 through the user computer 25 over the network 16.

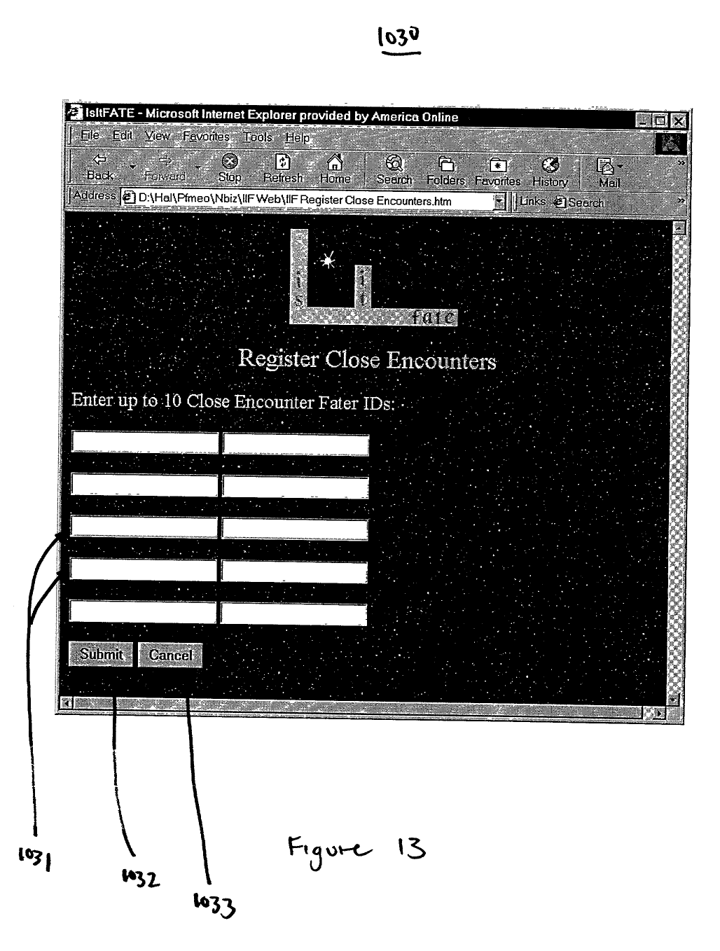

If the user chooses to enter ‘close encounters’ at step 211, the user will be presented with a ‘close encounters’ registration page 1030 at step 212. FIG. 13 shows an exemplary ‘close encounters’ registration page 1030. The page 1030 includes a plurality of text boxes 1031 for entering information, a “submit” button 1032, and a “clear” button 1033.

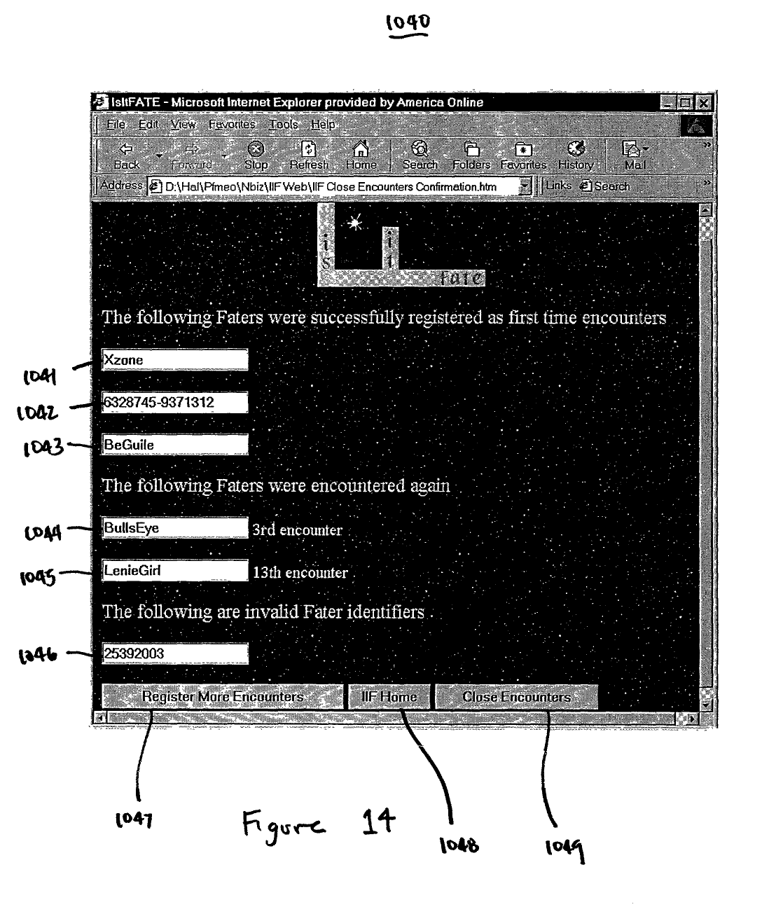

As stated above, the transceiver device 100 stores the unique codes of other transceiver devices which come in close proximity thereto. The unique codes may then be displayed on a display screen (LCD 115) of the transceiver device 100. These unique codes may comprise strings of numbers and letters which identify a particular transceiver device 100. These unique codes may be entered in the text boxes 1031 by a user through an associated user computer 25. Once the unique codes have been entered, the user is presented with a confirmation page 1040 (See FIG. 14) at step 213.

FIG. 14 shows a confirmation page 1040 which identifies first time encounters, multiple-time encounters, and invalid unique codes. Text boxes 1041-1043 display codes (1042) or user names (1041, 1043) of transceiver devices which have been encountered for the first time (‘first time encounters’). If a user encountered has not yet registered his or her transceiver device 100, the unique code of the particular transceiver device will be displayed instead of the user‘s login ID, such as with the user appearing in text box 1042. Text boxes 1044 and 1045 show users which have been encountered more than once (the specific number of encounters being listed outside the text box). Similarly to text boxes 1041-1043, if a user encountered more than once has failed to register his or her transceiver device, a unique code will appear in the text boxes 1044 and 1045 rather than the user's login ID. Text box 1046 shows unique codes which are invalid, based on either lack of a corresponding transceiver, or discontinuance of service. In most cases, unique codes which appear in the invalid text boxes are codes which were erroneously entered in the ‘close encounters’ registration page 1030 by the user (e.g., the code is off by one character or another). Of course it will be understood that the above-described confirmation page 1040 is only exemplary, and any number of text boxes may appear on any given confirmation page depending on the number of other users encountered.

The confirmation page 1040 also preferably includes a “register more encounters” button 1047 which returns the user to the ‘close encounters’ registration page 1030 (step 221), a “IIF home” button 1048 which returns the user to the main webpage 1000 (step 204), and a “close encounters” button 1049 which relays users to a ‘close encounters’ page (step 219), described below with reference to FIG. 16. Again, the above-described selection buttons 1047-1049 are only intended as exemplary, and it will be understood that any number of selection buttons may be utilized on the confirmation page 1040.

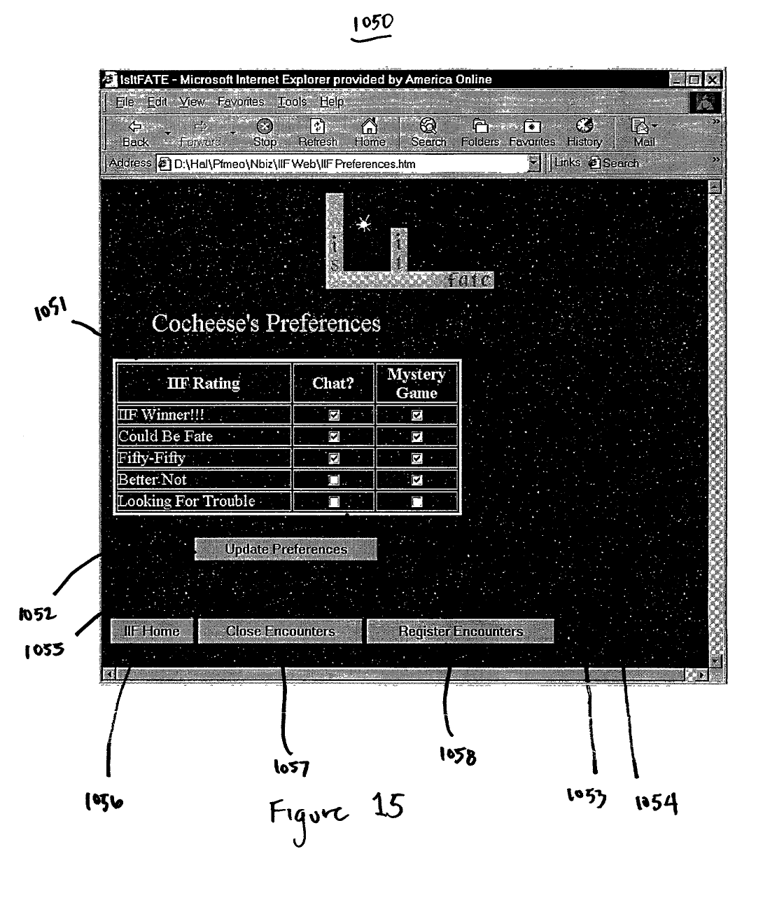

Referring again to FIG. 3, once ‘logged in’ to the system, the user may also choose to display a user preferences page 1050 at step 214. FIG. 15 shows an exemplary user preferences page 1050 which includes a table 1051 with various columns 1052-1054. Column 1052 lists possible ‘ratings’, columns 1053 and 1054 comprise “chat” and “mystery game” columns which include check mark boxes for allowing a user to select his or her particular contact preferences (explained below). When a user selects to display his or her particular user preferences page 1050, program module 22 retrieves the particular user data from a user preferences array (stored on IIF Database 810 but not shown in FIG. 9) at step 215, and displays the particular user preferences page 1050 on the video screen 18 of the user's computer 25 at step 216. The user preferences array is preferably stored on the server 12, but may also be stored on the user's computer 25 or any other suitable location.

The user preferences array may comprise a chat game component and a mystery game component, each with five (5) allowable entries per user, corresponding to the five different rating preferences (IF Winner!!!, Could Be Fate, etc.). For example, a “1” in the first entry of the chat game component of the user preferences array may correspond to a selection of the check mark box in the “IIF Winner!!!” row of the chat column 1053 of user preferences table 1050 (See FIG. 15). The table below illustrates an exemplary entry for a user who has chosen to chat with only those users who match “Fifty-Fifty” or better (the “1”s corresponding to a check mark in each of the first three entries of chat column 1053 in user preferences table 1050, and the “0”s corresponding to no check mark), and has chosen to play the mystery game with only those users who match “Better Not” or better (the “1”s corresponding to a check mark in each of the first four entries of mystery game column 1053 in user preferences table 1050, and the “0”s corresponding to no check mark).

User_Preferences_Array [1]
Chat_Game = [1, 1, 1, 0, 0]
Mystery_Game = [1, 1, 1, 1, 0]

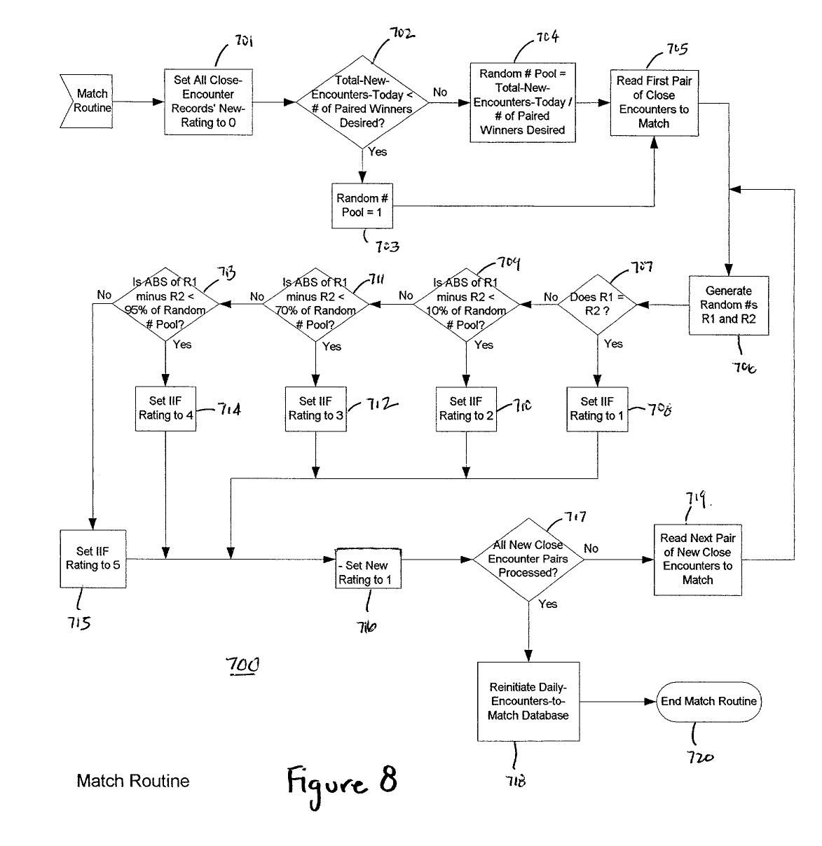

In the exemplary embodiment of the invention the user selects from amongst five (5) different preference ratings: “IIF Winner!!!”, “Could Be Fate”, “Fifty-Fifty”, “Better Not” and “Looking for Trouble”, however, any number of preference ratings may be utilized. Each of the preference ratings corresponds to a ‘rating’ which is assigned by the present process during match routine 700 (See FIG. 8). As shown in FIG. 15, a user selects or deselects check mark boxes in chat and mystery game columns 1053, 1054 in order to choose his or her preferences.

For example, if a particular user only wants to engage in chat with other users who have a ‘rating’ of “Fifty-Fifty” or better (IIF Ratings 1-3), he would only place check marks in the top three boxes in chat column 1053. Further, if a particular user only wants to engage in a mystery game with other users who have a ‘rating’ of “Better Not” or better (IIF Ratings 1-4), he would only place check marks in the top four boxes in mystery game column 1054.

The user preferences page 1050 shown in FIG. 15 also includes an “update preferences” button 1055 for refreshing the user preferences page 1050 when a user selects or deselects certain check marks in columns 1053 and 1054. The user preferences page 1050 also includes an “IIF Home” button 1056 (for returning the user to the main webpage 1000), a “close encounters” button 1057 (for forwarding the user to ‘close encounters’ page 1060), and a “register encounters” button 1058 (for forwarding the user to ‘close encounters’ registration page 1030).

A ‘logged in’ user may also at any time select to view a ‘close encounters’ page 1060 by selecting a “close encounters” button from any one of selected webpages (e.g., “close encounters” button 1049 in FIG. 14, “close encounters” button 1006 in FIG. 10). The selection to display the ‘close encounters’ page takes place at step 217 of the present process 200. As with the user preferences page above, when a user selects to display his or her particular ‘close encounters’ page 1060, the program module 22 retrieves the particular user data from a Close Encounter Record array 820 for the particular user (See FIG. 9) at step 218, and displays the particular ‘close encounters’ page 1060 at step 219. As stated above, the Close Encounter Record array 820 is preferably stored on the server 12, but may also be stored on the user's computer 25 or any other suitable location.

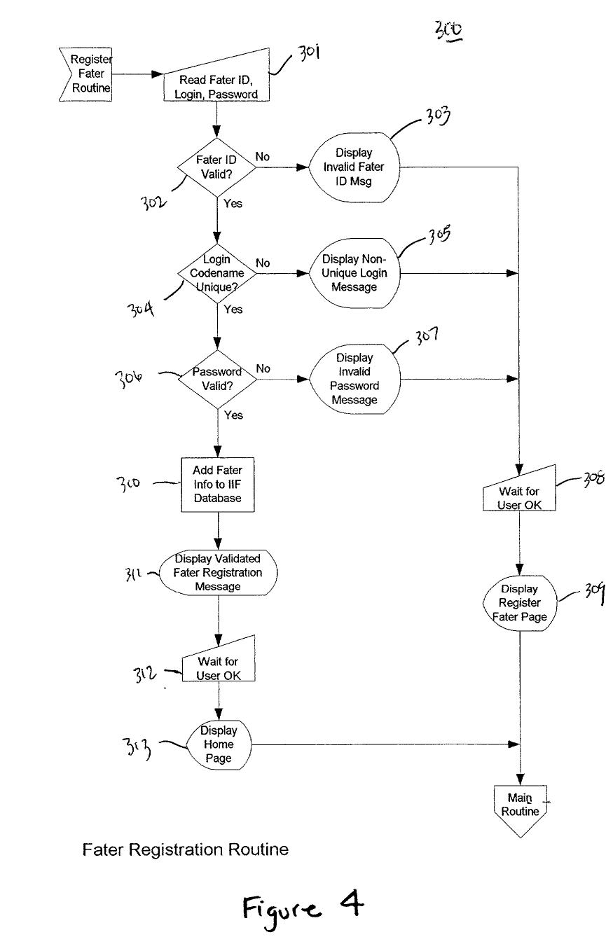

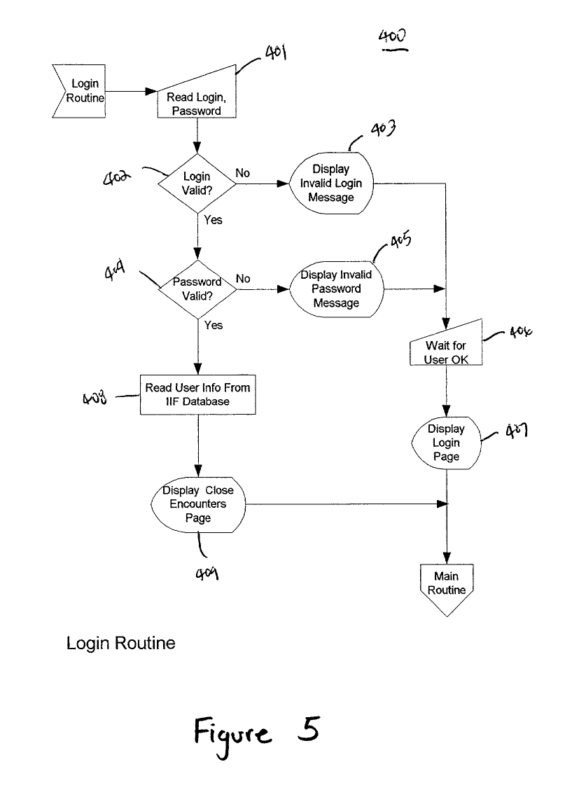

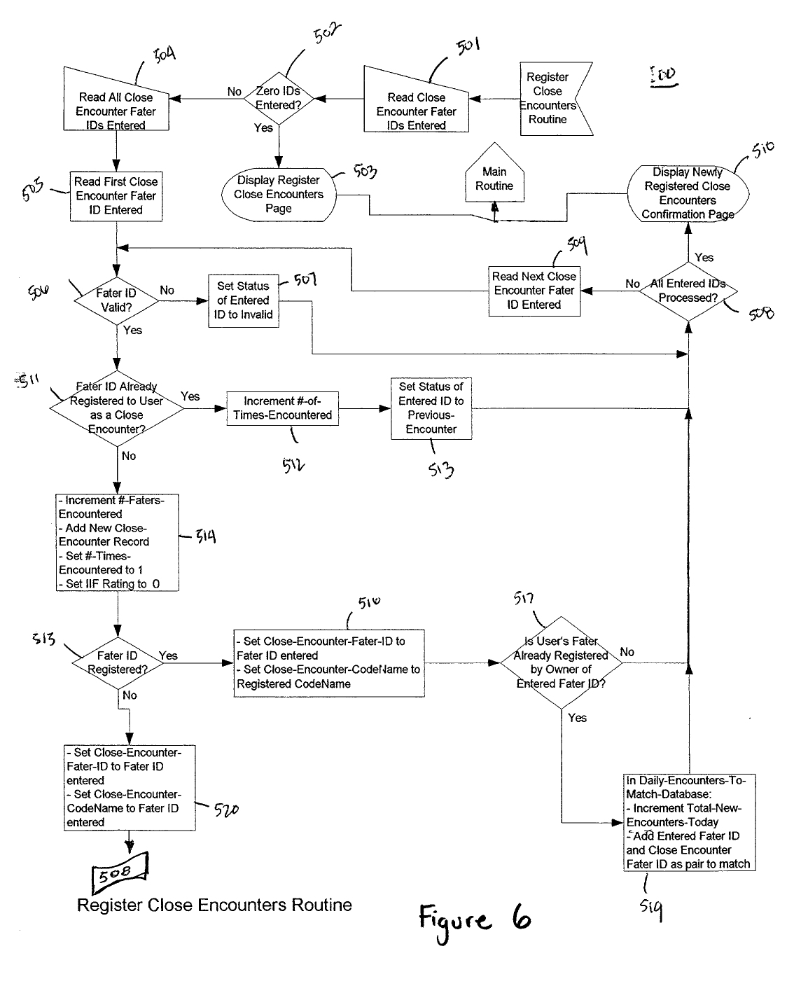

The remainder of the present process 200 involves different routines for implementing the different functions described above (e.g., login, registration, etc.). Beginning with step 220, if a user has submitted a ‘close encounters’ at ‘close encounters’ registration page 1030, a close encounters registration routine (See FIG. 6) will be run at step 221. If the user has submitted a login ID and password at login page 1020 (step 222), then a login routine (See FIG. 5) will be run at step 223. If the user has chosen to register his or her transceiver device 100 at registration page 1010 (step 224), a Fater registration routine (See FIG. 4) will be run at step 225. Finally, if a user chooses to change his or her user preferences at user preferences page 1050 (step 225), a change preferences routine is run at step 226.

There are at least two additional routines which are part of the present process 200. Both of these routines are preferably selected from the ‘close encounters’ page 1060. As shown in FIG. 16, there are two columns for “chat” and “mystery game”, with various entries for each user with which the present user has had a close encounter. If an “OK” appears in the “chat” column next to a particular user, the user will accept being contacted through a chat program. Preferably, the “OK” indicator in the “chat” column comprises a hyperlink which initiates a chat program between the users. Similarly, if an “OK” appears in the “mystery game” column next to a particular user, it indicates that the user wishes to participate in the mystery game.

The mystery game preferably comprises a game played over the network 16 (e.g., Internet or Intranet) between users. The game may comprise a guessing-type game where each of the users attempts to guess the identity of the other user after being given a plurality of clues in succession. Alternatively, the game may comprise an action (e.g., Doom®, Quake®, etc.) or sports game (e.g., football, basketball, etc.) played by the users against one another.

FIG. 4 shows a Fater registration routine 300 which is conducted each time a user has chosen to register his or her transceiver device 100 at registration page 1010 (step 224). The Fater registration routine 300 begins at step 301 by reading the transceiver device serial number (i.e., “Fater Identifier”), login ID and password entered in text boxes 1011-1013 by the user. It should be noted that the transceiver device serial number or Fater Identifier is the unique code which the transceiver continually transmits. At step 302, it is determined whether the transceiver device serial number enter is valid. Server 12 preferably includes an IIF Database 810 which includes an Serial Number array (not shown in FIG. 9) of valid transceiver serial numbers to which the current transceiver serial number is compared. If the serial number is invalid, the process proceeds to step 303, where a message is displayed on the video screen 18 of the user's computer 25 (preferably in the form of a dialog box) indicating that the serial number is invalid. At this point, the user may select an “OK” button in the dialog box (step 308) to return to the main registration page 1010 (step 309).

If the serial number entered is valid, the process proceeds to step 304 where it is determined whether the login ID chosen is unique (i.e., whether some other user has already chosen the particular login ID). As stated above, server 12 preferably includes an IIF Database 810 which includes a IIF ID Record array 812 for each user of the system which indicates each user's login ID in the FaterLogin Codename component 814 of the array. The presently selected login ID is then compared to the IIF ID Record array 812 for each user to determine if the selected login ID is valid (i.e., not already selected by another user. If the login ID is determined to be invalid (i.e., unavailable for use), the process proceeds to step 305, where a message is displayed on the video screen 18 of the user's computer 25 (preferably in the form of a dialog box) indicating that the login ID is invalid. At this point, the user may select an “OK” button in the dialog box (step 308) to return to the main registration page 1010 (step 309).

If the login ID is determined valid, the process proceeds to step 306 where it is determined whether the password chosen contains at least a minimum number of alpha-numeric characters, and no more than the maximum number of alpha-numeric characters, and no non-alpha-numeric characters. If the password is determined to be invalid, the process proceeds to step 307, where a message is displayed on the video screen 18 of the user's computer 25 (preferably in the form of a dialog box) indicating that the password is invalid. At this point, the user may select an “OK” button in the dialog box (step 308) to return to the main registration page 1010 (step 309).

If the password is determined valid, the process proceeds to step 310 where the entered Serial Number, login ID and password are stored in the IIF Database as a new record in the IF ID Record array 812. Then, a Fater registration confirmation dialog box is displayed at step 311. The Fater registration confirmation dialog box preferably includes an “OK” button which the user may select at step 312, thereby causing the main webpage 1000 to be displayed at step 313.

FIG. 5 shows a login routine 400 which is conducted each time a user has chosen to login by submitting a login ID and password at login page 1020 (step 222). The login routine 400 begins at step 401 by reading the login ID and password entered in text boxes 1021-1022. At step 402, it is determined whether the login ID entered is valid by comparing the current login ID to a login ID database stored on the server 12 and described above. If the login ID is determined to be invalid, the process proceeds to step 403, where a message is displayed on the video screen 18 of the user's computer 25 (preferably in the form of a dialog box) indicating that the login is invalid. At this point, the user may select an “OK” button in the dialog box (step 406) to return to the main login page 1020 (step 407).

If the login ID is determined valid, the process proceeds to step 404 where it is determined whether the password chosen is valid. Again, server 12 includes a password database of passwords to which the current password is compared. If the password is determined to be invalid, the process proceeds to step 405, where a message is displayed on the video screen 18 of the user's computer 25 (preferably in the form of a dialog box) indicating that the password is invalid. At this point, the user may select an “OK” button in the dialog box (step 406) to return to the main login page 1020 (step 407).

If the password is determined valid, the process proceeds to step 408 where the user's specific information is retrieved from a database. Then, the user's ‘close encounters’ page is displayed at step 409, and the control is returned to the main process 200.

FIG. 6 shows a ‘close encounters’ registration routine 500 which is conducted each time a user has chosen to register ‘close encounters’ at ‘close encounters’ registration page 1030 (step 221). The ‘close encounters’ registration routine 500 begins at step 501 by reading the unique codes (i.e., transceiver serial numbers) entered in text boxes 1031. It is then determined at step 502 whether any unique codes have been entered in the text boxes 1031. If no unique codes have been entered in the text boxes 1031, the ‘close encounters’ registration page 1030 is redisplayed at step 503 and control is returned to the process 200. However, if at least one unique code is entered in one of the text boxes 1031, such unique codes are read at step 504. Then, each unique code is read separately at step 505, and each unique code is determined either valid or invalid at step 506. As described above, server 12 preferably includes an IIF Database 810 which includes an Serial Number array (not shown in FIG. 9) of valid transceiver serial numbers to which the current transceiver serial number is compared. Alternatively to a Serial Number array, an algorithm may be used to determine the validity of the entered unique code, as is well known in the art. If the Serial Number/unique code is determined invalid, a ‘status’ of the code is set to ‘invalid’ in a database at step 507. At this point it is determined whether all unique codes which were entered have been processed at step 508. If all unique codes have been processed, the ‘close encounters’ confirmation page 1040 (FIG. 14) is presented at step 510, and control is returned to the process 200. If additional unique codes need to be processed, the next unique code is read at step 509, and its validity is determined at step 506 as described above.

When a unique code is determined valid at step 506, the process 500 proceeds to step 511, where it is determined whether the unique code has been previously entered in the user's Close Encounter Record array 820 (See FIG. 9). This is determined by comparing the unique code entered to each Close Encounter Fater ID component 821 of the Close Encounter Record array 820. If the unique code has previously been entered, the Number of Times Encountered component of the array 820 for the particular user is incremented by 1 (e.g., from 2 to 3), and a ‘status’ of the unique code is set to ‘previous encounter’ at step 513, and the process returns to step 508 to check for the next unique code.

If the current unique code has not been entered previously, the process proceeds to step 514 where the Total Close Encounter Records component 817 of the user's IIF ID Record array 812 is incremented by 1 (indicating a new close encounter), and a new ‘close encounter’ record is added to the user's Close Encounter Record array 820. When the new ‘close encounter’ record is entered in the database 810, the Number of Times Encountered component 823 is set to “1”, the IF Rating component is set to “0” (temporarily), and the New Rating component is set to “0” (temporarily).

Next, at step 515, it is determined whether the unique code entered corresponds to a registered transceiver device (i.e., whether the unique code has an associated login ID). This is accomplished by comparing the unique code to the Fater Identifier component 813 of the IIF ID Record array 812. If the unique code corresponds to a registered transceiver (i.e., is present in one of the Fater Identifier components 813 of the IIF ID Record array 812), the Close Encounter Fater ID component 821 of the new ‘close encounter’ record is set to the encountered user's transceiver device 100 unique code or Serial Number, and the Close Encounter Codename component 822 of the new ‘close encounter’ record is set to the encountered user's corresponding login ID at step 516.

If the unique code does not correspond to a registered transceiver (i.e., is not present in one of the Fater Identifier components 813 of the IIF ID Record array 812), the Close Encounter Fater ID component 821 of the new ‘close encounter’ record is set to the encountered user's transceiver device 100 unique code or Serial Number, and the Close Encounter Codename component 822 of the new ‘close encounter’ record is also set to the encountered user's transceiver device 100 unique code or Serial Number at step 520. The process then proceeds back to step 508 where it is determined if all encounters have been processed, and the process proceeds as described above.

After the unique code entered is referenced to a particular login ID at step 516, it is determined whether the user associated with the particular login ID has previously registered the user now entering the information into the system at step 517. In other words, once it has been determined that the user you have encountered has registered her transceiver, it must be determined whether that user has also entered you in his ‘close encounters’ database (i.e., whether the user has a record in her Close Encounter Record array which corresponds to you).

If the user associated with the particular login ID has entered the user now entering the information in the system, the process proceeds to step 519 where a Daily Encounters to Match Database 850 is updated. In particular, a Total New Encounters Today array 851 is incremented by 1 (e.g., from 2 to 3), and a new record is entered in the Encounter Pairs array 852. A Fater Identifier component 853 of the Encounter Pairs array 852 is set to the Serial Numbers or unique codes for the two users, an IIF ID Record Number component 854 is set to the respective number associated with each user, and a Close Encounter Record Number component 855 is set to the respective number associated with each user in each other's Close Encounter Record array 820.

If the user associated with the particular login ID has not entered the user now entering the information in the system, the process proceeds to step 508, where it is determined if all encounters have been processed, and the process proceeds as described above. Thus, according to the exemplary embodiment of the present process, new ‘close encounters’ are only logged to the Daily Encounters to Match Database 850 when both users have registered their transceiver devices 100 (i.e., created an associated login ID), and the users come in close proximity to one another.

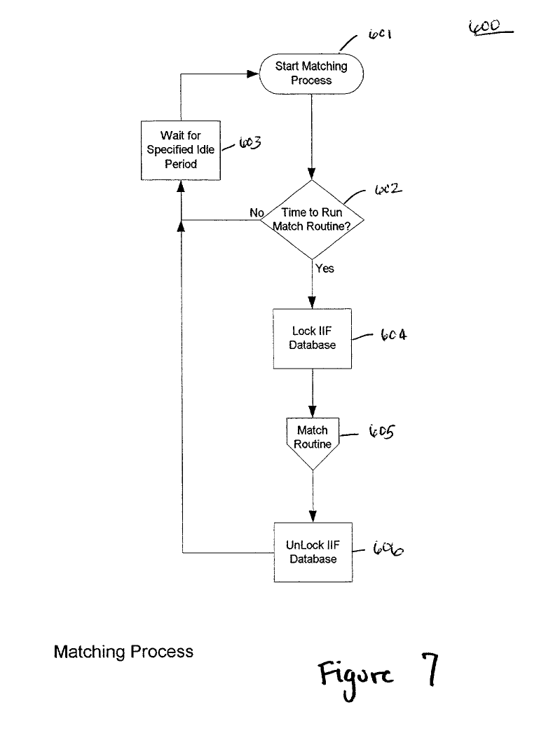

FIG. 7 shows a matching process routine 600 which operates to match ‘close encounters’ and create ‘ratings’ for each ‘close encounter.’ The matching process routine starts at step 601, and is typically run continuously while server 12 is active. At step 602, it is determined whether it is time to run a match routine 700 (explained below; FIG. 8). Preferably, server 12 has an associated timer or clock which keeps track of the current date and time. The match routine can be run at any specified interval, but is preferably run at least once a day at a time when user activity is low (e.g., 4:00 am). The process continually checks the time of the server clock to determine if the specified time has been reached. If the specified time is not yet at hand (e.g., it is 3:50am), the process waits for a specified period (e.g., 5 minutes) at step 603, and then runs another time check at step 602. When the server clock reaches the specified time, the IIF Database 810 is locked at step 604, so that no new user information may be entered. Then, a match routine 700 is run at step 605 (See FIG. 8), the IIF Database is unlocked at step 606, and the process again waits for a specified time to perform the matching process routine 600 again (e.g., 4:00 am on the following day).

FIG. 8 shows a match routine 700 which is run at a specified time each day (e.g., 4:00 am each day), and which updates the Daily Encounters to Match Database 850 at the specified time. The match routine begins at step 701 where the New Rating component 825 of each ‘close encounter’ logged to the Encounter Pairs array 852 is set to “0.” In particular, the ‘close encounters’ identified by the Close Encounter Record Number component 855 of the Encounter Pairs array 852 are all accessed, and the New Rating component 825 of each is set to “0”, indicating that a ‘rating’ has yet to be performed. Then, the number in the Total New Encounters Today array 851 is compared to a specified number which indicates the number of ‘winners’ which are desired for the match routine 700. The number of ‘winners’ allowed per polling cycle is preferably set by the operator of the process 200 each day, but may also be set automatically by a computer program daily from amongst a group of authorized numbers.

If the total number of new encounters for the polling period is less than the number of allowed ‘winners (not a preferred result), a random number pool is set to “1” at step 703, and then the close encounters are read a pair at a time from the Encounter Pairs array 852 at step 705. The random number pool is a pool of numbers ranging from “1” to the number selected from which a number is selected at random. Thus, when the random number pool is set to “1”, only one possible number can be generated (i.e., “1”).

If the total number of new encounters for the polling period is greater than the number of allowed ‘winners, the random number pool is set to a range of values at step 704.

The range is determined by the formula below:

Random Number Pool=(Total New Encounters/Number of Allowed Winners)

For example, if there were 100 new close encounters in a particular day (polling period), and the number of allowed winners was set to five (5), the random number pool would be twenty (20), and therefore the random numbers generated would range from “1” to “20.” Then, the close encounters are read a pair at a time from the Encounter Pairs array 852 at step 705.

As each encounter pair is read at step 705, two random numbers “R1” and “R2” are generated. If R1 and R2 are equal, the IIF Rating component 824 for the specific user in each pair will be set to 1. If R1 and R2 are not equal, an algorithm sets the IIF Rating to a number based on how close R1 and R2 were to each other. For example, if the difference between R1 and R2 were less than 10% of the highest possible number in the Random Number Pool, the IIF Rating component 824 would be set to 2. If the difference was less than 75% it would be set to 3, less than 95% set to 4, or greater than or equal to 95% the IIF Rating 824 would be set to 5. After assigning an IIF Rating component 824, the New Rating component 825 for the specific encounters in the IIF Database 810 would be set to 1. Once all the encounter pairs in the Daily Encounters to Match Database 850 have been processed, the Database 850 is reinitialized (e.g., all entries are deleted and/or moved to a backup database).

Referring again to FIG. 3, if the user at any time chooses to cancel the process 200, he or she may do so by selecting a “cancel” button from any screen on which the button appears (step 232) (See FIGS. 11, 13). When the user selects to cancel, the browser program 20 of the user's computer 25 re-presents the main webpage 1000 at step 233.

If the user chooses not to cancel, a fail safe check is performed at step 234, and the process proceeds to await further instructions at step 202.

FIG. 16 shows a ‘close encounters’ page 1060 which includes a ‘close encounters’ table 1061 which is generated every time a user selects the “close encounters” button on the video screen 18 of his or her computer 25. As described above, the “close encounters” button is offered on many described webpages including the main webpage 1000 (FIG. 10), the ‘close encounters’ confirmation page 1040 (FIG. 14), and the user preferences page 1050 (FIG. 15). The ‘close encounters’ table 1061 preferably includes at least six (6) columns, including a ‘close encounters’ user column 1062, an “IIF rating” column 1063, a “chat” column 1064, a “mystery game” column 1065, a ‘close encounters’ number total column 1066, and a “New rating” column 1067.

As stated above, there are at least five (5) different ‘ratings’ which may be assigned to any two users who have a ‘close encounter.’ Each ‘rating’ has an associated reference number preferably ranging from one (1) to five (5). For instance, the “IIF Winner” rating preferably corresponds to the number “1”, the “Could Be Fate” rating preferably corresponds to the number “2”, and so on, with the “Looking For Trouble” rating preferably corresponding to the number “5.” Depending on each user's chosen preferences (as set on user preferences page 1050; FIG. 15), and the ‘rating’ given to each pair of users, a variety of messages may appear in the chat and mystery game columns 1064, 1065. For example, if the user viewing the ‘close encounters’ page 1060 has set his preferences to chat with only those close encounters rated “Fifty-Fifty” or better, any close encounters which are rated lower (i.e., “Better Not” or “Looking For Trouble”) will have a decline message in the chat column 1064 (See users “LikeThis”, “Xzone”, “BeGuile” and “LooseChange” in FIG. 16). If other users have set their preferences similarly (i.e., to chat with only those users rated “Fifty-Fifty” or better), a message indicating that both users decline will be posted in the chat column 1064 (See user “LikeThis” and “BeGuile”). As will be apparent, the mystery game column 1065 is handled in a similar manner. It should also be noted that users who have not registered their transceiver devices 100 (‘Faters’) will not be given a ‘rating’ by the system, and will receive a “Not Registered” message in the IIF Rating column 1063 of the ‘close encounters’ table 1061.

The ‘close encounters’ page 1060 also includes a “preferences” button 1068 for displaying a user preferences page 1050, an “IIF Home” button 1069 for returning the user to the main webpage 1000, and a “register encounters” button 1070 for forwarding the user to ‘close encounters’ registration page 1030. The above-described selection buttons 1068-1070 are only intended as exemplary, and it will be understood that any number of selection buttons may be utilized on the ‘close encounters’ page 1060.

Although the present invention has been described in terms of entering unique codes on a personal computer generally, it should be noted that the unique codes may be entered into a computer by any method know in the art at the time of the invention, including, but not limited to, through a keyboard, through a Personal Digital Organizer (PDA) coupled to a computer through a Uniform Serial Bus (USB) port or otherwise, through a wireless connection (e.g., cellular telephone, etc.), through a scanner, through a bar code reader, through any connection port on a standard personal computer (e.g., RS232, optical, etc.), and through any other means know to those skilled in the art at the time of invention.

Although the invention has been described in terms of exemplary embodiments, it is not limited thereto. Rather, the appended claims should be construed broadly, to include other variants and embodiments of the invention which may be made by those skilled in the art without departing from the scope and range of equivalents of the invention.

What is claimed is:

1. A method for facilitating communications between persons, comprising the steps of:
sensing when two or more persons come in contact with one another by storing a unique code in transceiver units disposed on each of the two or more persons;
providing an electronic medium for entering the unique codes stored -on the transceiver units; and,
randomly matching pairs of users based on a matching program accessible by the electronic medium.

2. The method of claim 1, wherein the electronic medium comprises a personal computer.

3. The method of claim 1, wherein the electronic medium comprises a personal computer connected to a server computer over a network.

4. The method of claim 1, comprising the further step of:
generating at least first and second levels of matching through the matching program;
permitting users who are both matched at a first level or a second level to contact one another through the electronic medium;
denying users who are at different matching levels the ability to contact one another through the electronic medium.

5. The method of claim 1, wherein the transceiver device comprises:
at least one memory unit for storing the unique codes received by the transceiver; and,
a display screen for displaying received unique codes.

6. The method of claim 5, wherein the transceiver device further comprises:
a timer circuit coupled to the at least one memory buffer; and,
a logic circuit for manipulating the received unique codes.

7. The method of claim 5, wherein the at least one memory unit includes:
at least one buffer; and
a first-in-first-out register coupled to the at least one buffer.

8. The method of claim 5, wherein the transceiver device further comprises a read-only memory for storing a particular unique code associated with the transceiver.

9. The method of claim 1, wherein the step of randomly matching pairs of users comprises:
generating at least one random number from a specified pool of numbers for each user of the pair of users;
determining if the random numbers generated for each user are equal; and,
permitting the users to contact one another through the electronic medium if the random numbers generated for each user are equal.

10. The method of claim 9, wherein the step of randomly matching pairs of users further comprises:
determining if the random numbers generated for each user are within a specified range of each other;
permitting the users to contact one another through the electronic medium if the random numbers generated for each user are within a specified range of each other; and,
prohibiting the users from contacting one another through the electronic medium if the random numbers generated for each user are not within a specified range of each other.

11. The method of claim 1, comprising the further step of:
generating a close encounters table for display on the electronic media, said close encounters table including at least one row identifying at least one of a pair of users who have been matched by the matching program, and at least one row indicating a matching level for each at least one of a pair of users who have been matched by the matching program.

12. The method of claim 4, wherein the step of permitting users who are both matched at the same matching level to contact one another comprises:
permitting the users to contact one another through a chat program.

13. The method of claim 12, wherein the electronic medium comprises a plurality of personal computers coupled to a server computer through a network, each personal computer being associated with a particular user, and
wherein the chat program may be accessed through a hyperlink present on respective video screens of each user's personal computer.

14. The method of claim 4, wherein the step of permitting users who are both matched at the same matching level to contact one another comprises:
permitting the users to contact one another through a game program.

15. The method of claim 14, wherein the electronic medium comprises a plurality of personal computers coupled to a server computer through a network, each personal computer being associated with a particular user, and
wherein the game program may be accessed through a hyperlink present on respective video screens of each user's personal computer.

16. The method of claim 1, wherein the electronic medium comprises a plurality of personal computers connected to a server computer over a network, each personal computer being associated with a particular user.

17. A computer system comprising:
at least one server computer; and,
at least one user computer coupled to the at least one server through a network,
wherein the at least one server computer includes at least one program stored therein, said program performing the following steps:
permitting a user stationed at the at least one user computer to enter unique codes which correspond to persons encountered; and,
generating a matching level for each unique code entered.

18. The computer system of claim 17, wherein said program performs the further step of:
permitting a user stationed at the least one user computer to register a transceiver device.

19. The computer system of claim 18, wherein said step of permitting a user to register a transceiver device comprises:
permitting a user to enter in the at least one user computer a unique code associated with the transceiver device;
permitting a user to choose a login identification; and,
permitting a user to choose a password.

20. The computer system of claim 19, wherein said program performs the further steps of:
validating the entered unique code;
validating the entered login identification; and,
validating the password.

21. The computer system of claim 17, wherein said program performs the further step of:
permitting a user stationed at the least one user computer to register encounters with other users.

22. The computer system of claim 17, wherein said program performs the further step of:
permitting a user stationed at the least one user computer to alter user preferences relating to which other users may contact the at least one user.

23. The computer system of claim 21, wherein the step of permitting a user to register encounters with other users comprises:
accepting unique codes entered by the user, each said unique code indicative of a user encountered;
comparing each said unique code entered to a database of unique codes and associated login identifications;
determining if the unique code entered corresponds to an associated login identification;
registering the entered unique code and associated login identification as an encounter if it is determined that the unique code entered corresponds to an associated login identification; and,
prohibiting registration of the entered unique code as an encounter if it is determined that the unique code entered does not corresponds to an associated login identification.

24. The computer system of claim 17, wherein the step of generating a matching level comprises:
generating a pool of numbers;
selecting first and second random numbers from the pool of numbers; and
assigning a matching level to a pair of users based on the random numbers selected from the pool of numbers.

25. The computer system of claim 24, wherein the step of generating a pool of numbers comprises generating a pool of numbers from one to a first pool number selected according to the following formula:
first pool number=(total number of users encountered)−(number of desired winners),
wherein the total number of users encountered comprises the number of unique codes entered, and the number of desired winners comprises a particular number selected by an operator of the computer system.

26. The computer system of claim 24, wherein the step of assigning a matching level comprises:
assigning a first matching level if the first random number selected is equal to the second random number selected;
assigning a second matching level if the absolute value of the result of subtracting the first random number from the second random number is less than ten percent of the first pool number;
assigning a third matching level if the absolute value of the result of subtracting the first random number from the second random number is less than seventy percent of the first pool number;
assigning a fourth matching level if the absolute value of the result of subtracting the first random number from the second random number is less than ninety-five percent of the first pool number; and,
assigning a fifth matching level otherwise.

27. The computer system of claim 26, comprising the further step of:
permitting pairs of users to contact other electronically based on the matching level assigned to each pair of users.

28. The computer system of claim 27, wherein the step of permitting pairs of users to contact each other electronically comprises:
allowing a user to select specific matching levels for electronic communications;
permitting only other users who meet the specified matching levels to electronically contact the user; and,
prohibiting users who do not meet the specified matching levels from electronically contacting the user.

29. The computer system of claim 28, wherein the electronic communications comprise a chat program.

30. The computer system of claim 28, wherein the electronic communications comprise a game program.

31. A computer system comprising:
at least one server computer; and,
a plurality of user computers coupled to the at least one server through a network,
wherein the at least one server computer includes at least one program stored therein, said program performing the following steps:
permitting a user stationed at any one of the plurality of user computers to enter unique codes which correspond to other users encountered; and,
generating a matching level for each unique code entered.

32. A computer readable medium having embodied thereon a computer program for processing by a machine, the computer program comprising:
a first code segment for permitting a user stationed at the at least one user computer to enter unique codes which correspond to persons encountered; and,
a second code segment for generating a matching level for each unique code entered.

33. The computer readable medium of claim 32, wherein said computer program further comprises:
a third code segment for permitting a user stationed at the least one user computer to register encounters with other users.

34. A computer data signal embodied in a carrier wave comprising:
a first code segment for permitting a user stationed at the at least one user computer to enter unique codes which correspond to persons encountered; and,
a second code segment for generating a matching level for each unique code entered.

35. The computer data signal of claim 34, wherein said computer program further comprises:
a third code segment for permitting a user stationed at the least one user computer to register encounters with other users.

36. A computer system whose actions are directed by a computer program configured as a multiple database information exchange management system, comprising:
a first database of information relating to participants in a process for making random introductions electronically, stored in electronically readable memory;
a second database of information relating to encounters which occur between the participants, stored in electronically readable memory;
a communications port suitable for transmitting and receiving data and instructions in the form of electrical signals to and from at least one remote computer; and,
a database manager for creating and revising records stored in said first database and said second database, responsive to said data and instructions from said at least one remote computer,
wherein only users identified by the system as vendors may create and revise the first database.
